(19) United States
(12) Patent Application Publication
(10) Pub. No.: US 2016/0246941 A1
(43) Pub. Date: Aug. 25, 2016

(54) MEDICATION MANAGEMENT

(71) Applicant: CERNER INNOVATIONS, INC., Kansas City, KS (US)

(72) Inventors: Shadeequa Miller, Clinton, MD (US); James M. Walker, New Cumberland, PA (US); Shipeng Yu, Exton, PA (US); Jodi Kodish-Wachs, Cherry Hill, NJ (US); Bijan John Parsia, Hulme (GB); Balaji Krishnapuram, King of Prussia, PA (US)

(21) Appl. No.: 14/626,280

(22) Filed: Feb. 19, 2015

(51) Int. Cl. G06F 19/00

(52) U.S. Cl. CPC G06F 19/3456; G06F 19/322

(57) ABSTRACT

Managing a medication may involve identifying an event relating to the medication. Managing a medication may also involve determining a task for a course of care of a patient due to the event relating to the medication, and providing a notification to interested parties regarding the task and the event relating to the medication.

### FIELD

The present embodiments relate to medication management. Specifically, the present embodiments relate to managing a medication based on data indicating events of the medication life cycle.

### BACKGROUND

Healthcare facilities and organizations use electronic systems to store and manage a considerable amount of medical data, from various sources and in various formats, for specific patients. This patient data may be representative of the medical care during a course of care for a patient.

A medical course of care for a patient may involve multiple medication interventions, treatment plans and tasks as well as various treatment venues, entities, and specific providers involved in the enacting of respective plans. Each of these venues, entities, and specific providers must coordinate over the course of a patient's life, and often across significant distances, to execute the respective medication interventions. This complicated interaction of multiple medication interventions, treatment plans, tasks, venues, entities, and providers may provide confusion for both patients and/or care providers as to who is responsible for overseeing the management of a course of care for a patient, particularly the administering and oversight of medication interventions. For example, a patient may be placed on a particular medication by a physician, and many years later there may be a more effective medication available for the market, but the patient and the prescribing physician are no longer in communication. Also, new details regarding risks and/or benefits of a medication may be discovered that should be communicated to patients using the medication.

The organization for patient course of care management is a largely manual process, and as such, is error prone For example, a lack of up-to-date knowledge regarding who is on a patient's care team, as well as a lack of effective communication among care team members, complex information and requirements regarding safe and effective use of medications, large and increasing numbers of medications and medication formulations, confusing medication safety compendia, a lack of reimbursement and/or other incentives for effective identification of many critical stages of medication management or intervention often result from manually balanced and/or managed care for a patient.

Due to this complicated interaction and possible confusion, many patients experience preventable uncertainty, anxiety, and/or inadequate treatment. Adverse medication effects due to undetected adverse medication interactions with other medications and/or an incompatibility or high risk usage due to conflicting medication and patient characteristics may result. Also, medical practitioners may experience anxiety, low quality ratings, legal exposure, and/or increased costs.

### BRIEF SUMMARY

By way of introduction, the preferred embodiments described below include methods, computer readable media, and systems for managing a medication intervention in a health care setting. To facilitate the management of the medication, an event relating to the medication is identified. The event may be used to indicate a change in a characteristic of a medication, or a change related to the medication. This change, event, and/or associated information is communicated to pertinent parties for the patients' course of care, such as a patient and/or treatment providers for the patient to whom the medication is prescribed.

In a first aspect, a method is presented for managing a medication. The method may involve identifying data indicative of an event relating to the medication, the event involving a change related to the medication. The method may also involve determining at least one task for a course of care of at least one patient due to the change related to the medication. The method may also involve selecting, through access of a treatment provider repository in a database, at least one treatment provider for the at least one patient, the treatment provider selected from a plurality of treatment providers having associated provider attributes, and the selecting being based on the change related to the medication, the provider attributes, and at least one patient characteristic from a patient medical record database, and providing to the selected at least one treatment provider a notification that indicates the event, the identified at least one patient, and that the selected treatment provider is a designated treatment provider for the at least one task.

In a second aspect, a system is presented for managing a medication. The system may involve at least one memory operable to store a database comprising a treatment provider repository having a plurality of treatment providers, the plurality of treatment providers associated with provider attributes, and an electronic patient medical record database. The system may also involve a processor configured to identify data indicative of an event relating to the medication, the event involving a change related to the medication, determine at least one task for a course of care of at least one patient due to the change related to the medication, select, by accessing the treatment provider repository, at least one treatment provider for the at least one patient, the treatment provider selected from a plurality of treatment providers having associated provider attributes, and the selecting being based on the change related to the medication, the provider attributes, and at least one patient characteristic from a patient medical record database, and provide to the selected at least one treatment provider a notification that indicates the event, the identified at least one patient, and that the selected treatment provider is a designated treatment provider for the at least one task.

In a third aspect, a system for managing a medication is presented. The system may involve an electronic medical record system comprising a plurality of electronic medical records of patients. The system may also involve a treatment provider repository comprising a plurality of treatment providers having associated provider attributes. The system may also involve a medication management system configured to identify data indicative of an event relating to the medication, the event involving a change related to the medication relative to a patient, determine at least one task for a course of care of the patient due to the change related to the medication, select, by accessing the treatment provider repository, at least one treatment provider for the patient, the treatment provider selected from a plurality of treatment providers having associated provider attributes, and the selecting being based on the change related to the medication, the provider attributes, and at least one patient characteristic from a patient medical record database. The system may also involve a monitoring device configured to receive data indicative of the status of the course of care of the patient, and a notification device configured to provide to the selected at least one treatment provider a notification that indicates the event, the identified patient, that the selected treatment provider is a designated treatment provider for the at least one task, and data indicative of an adverse event by a particular patient to the medication, wherein the adverse event is the data indicative of the event relating to the medication.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 illustrates an embodiment of a system for medication management;

FIG. 2 shows a flow chart diagram of one embodiment of a method for medication management;

FIG. 3 illustrates a flow chart diagram of another embodiment of a method for medication management;

FIG. 4 provides an illustrative embodiment of a computer system for medication management; and

FIG. 5 is an example of an electronic medical record used to store medical information of tasks for a course of care for patients using various fields.

### DETAILED DESCRIPTION OF THE DRAWINGS AND PRESENTLY PREFERRED EMBODIMENTS

An event or change related to a medication is identified. The event is identified from data input by a user, received from a device of one or more patient, and/or from other sources. The event or change may be a completion of a treatment plan milestone involving the medication, the entry of the patient into a critical stage of a treatment plan involving the medication, a change in state (e.g., health) of the patient taking the medication, the retirement of a medication, an indication that there is a more effective medication available, newly identified risks of a medication, and/or any other event regarding the use of a medication. The event or change may be used to indicate a change in the course of care. This change and/or associated information is communicated to pertinent parties involved in management of the medication and its use by patients, such as patients and/or treatment providers making up the care team for the patients. The progress of patients' course of care, particularly as the care relates to use of the medication, may be monitored, reported to pertinent parties, and/or used to identify an event related to the medication. Also, a treatment provider from a treatment provider repository, or other group of potential treatment providers, may be selected for a patient based on the change of characteristics in the medication.

A care team may be established and/or implied to provide oversight or execution of tasks, such as the administration or oversight of medication, during the course of care for patients. The care team may include any practitioner and/or organization involved in the course of care for a patient. For example, a care team may include the patient, physicians, lay caregivers, nurses, desk clerks, pharmacists, ancillary service providers, care managers, community health workers, first responders, home health workers, long term and/or post-acute care staff, and/or payers of health costs.

In an embodiment, each member of a care team for a patient is enabled through the use of a system as described herein to optimize their particular contribution to the safe and effective medication use throughout the course of care of a patient. A medication intervention and timing appropriate to each critical stage for each medication for a patient is identified by the system in light of the specific patient's clinical condition, goals, preferences, and capabilities. The system may also enable the care team through monitoring of the timely completion of each intervention of every patient under the care of the care team members, or every patient in a population. For example, a population may be a group of patients prescribed a medication and the care team may be notified of the people, that the care team members are associated with the patients' care, and of the progress of tasks related to the medication treatments. The system may also enable the care team through a prompting of the most cost-effective member of the care team to complete particular tasks for patients, such as medication interventions. For example, the system may determine a treatment provider to perform tasks associated with the course of care based on treatment provider characteristics indicating that they are qualified for the task, and have the lowest cost associated with performing the task when compared to other qualified providers. Patient characteristics may also be used.

A system and/or method implemented as described herein may connect health and information technology systems to patients and care-team members to provide medication treatment management outside of a point-of-care facility. This may involve solutions covering a full spectrum of virtualized medication management including:
identifying patients who benefit or are harmed from specific drugs;
managing medication pre-testing to determine drug candidacy;
calculating medication benefit-risk for patients;
sharing treatment plan decision making;
providing patient education;
facilitating patient self-management of medications, such as by collecting information from the patient and helping the care provider determine if the patient is a candidate for self-management of a treatment plan;
optimizing medication dosages;
monitoring positive and negative effects of a treatment plan;
predicting and/or managing adverse drug events;
conducting N-of-1 trials; and
facilitating the retirement of medications.

In an embodiment, a patient may be assisted with self-management of an in-home treatment plan. For example, a patient may be prescribed a medication treatment plan, such as a warfarin sodium medication intervention and/or medication schedule. Also, new information may be provided that indicate that the medication may be self-managed by a patient. A system may be configured to identify and assess if the patient is a candidate for medication self-management based on characteristics of the treatment plan and/or the medication. The system may further provide education for medication and self-management of the treatment plan, including purposes of the treatment, potential side effects, and/or training on required point-of-care devices and dosing regimes. The system may also determine a patient's preference for self-testing and/or treatment plan management. For example, a patient may provide responses to such queries using a patient device in communication with the system. Also, when a patient is deemed suitable for self-management of a treatment plan, the system may prompt the patient for input as to whether the patient wants to opt-into the self-management treatment plan. If an affirmative response is provided, the system may order or otherwise provide the necessary equipment for the patient, such as a testing kit. The system may also provide appropriate documentation of patient characteristics, such as international normalized ratio values (“INR”) and implied changes in medication dosing for the treatment plan. The system may also assess adherence to the protocols, facilitate clinical oversight with care givers, such as a pharmacist, and provide support services for the care givers.

Also, adverse drug events may be detected, predicted, and/or prevented based on identified and/or received data relating to a patient. In an embodiment, a system may collect input from a patient to predict an adverse drug event. The system may monitor medication treatment plans prescribed across care settings, providers, and/or venues. The system may also promote non-point-of-care management and/or prediction (i.e. through a pharmacist or nurse practitioner) of adverse drug events. For example, a system may track all medication prescriptions for a patient across all medical care providers of the patient. The system may also track all patients prescribed a medication. The system may analyze these medications and patients and determine if any of the prescribed medications are listed on, or have been entered into, a monitored list. If the medication is listed on a monitored list, the patient may be enrolled in a medication treatment plan tracking system.

Such a system may contact the patient, patient's care team, and/or a designated treatment provider for the enrolled medication treatment plan at a medication-specific frequency, via a preferred communication channel, to query about patient reactions to the medication. A preferred communication channel may involve a mode of communication, such as e-mail, telephone call, or SMS message, specified by a treatment provider or patient. The preferred communication channel may also involve a specified email address and/or telephone number. Further, the frequency and/or presented urgency of the contact may be determined based on a severity of a potential reaction and a probability of an occurrence of the potential reaction. For example, numerical values for severity may be assigned to a particular reaction, and probability values may be determined for a particular reaction. The frequency and/or presented urgency of the contact may then be determined based on a value determined from both values, such as by adding the values. Also, the contact may solicit general input as to the state and/or condition of the patient.

In this embodiment, if any of the contact queries are returned from the patient and/or care giver with an answer indicating the occurrence of a particular reaction, the system may initiate a reaction resolution process. A reaction resolution process may offer immediate and/or real-time advice to the patient or care giver. If immediate advice is not necessary, a next appropriate member, such as a designated treatment provider, of the care team for the patient is notified of the reaction event. Also, a report of the reaction event may be provided to the prescriber of the medication and/or primary care physician for the patient.

Adverse reactions to medication may also be predicted based on conditions or characteristics of a patient. In an embodiment, a system may inform women of child-bearing age of medication treatment plans considered dangerous for patients having such characteristics. This dangerous nature may have been previously known or determined based on new information entered into the system. The information may be sources from scientific studies, reactions to the medication from patients with similar characteristics, or any other source of information for the medication. The system may document a patient's informed consent to undertake the potentially dangerous treatment plans as well as provide care providers opportunities to inform and/or educate patients at appropriate times of the risks involved with such treatment plans. The system may connect to outpatient health information technology systems, such as electronic medical records systems of various providers of a patient's course of care, and monitor the systems for the introduction of treatment plans involving drugs previously or recently identified as potentially dangerous.

For example, teratogenic drugs (i.e. valproate or isotretinoin) may be considered dangerous drugs when combined with particular patient characteristics, such as a patient age and gender indicating a woman of child bearing age. When identified, such treatment plans may be referred by the system to a practitioner, such as a pharmacist or physician, to assess and/or evaluate the treatment plan and its potential adverse effects for the patient. The system may also refer, facilitate, and/or otherwise communicate the practitioner's recommendation in an actionable form to a physician indicated as the designated practitioner for the treatment plan. The system may also support the physician in documenting the appropriate indications and informed consent in the patient's electronic medical record, as well as provide educational materials to the patient regarding the risks associated with the patient's undertaking of the treatment plan. Further, a practitioner may be notified of multiple patients to which such treatment plans are applicable.

Also, patient characteristics may be taken into account for the particular design and/or selection of medication treatment plans for patients. For example, oral anticoagulant medications may be used to prevent stroke and/or atrial fibrillation in patients. For such a treatment plan to be effectively implemented, specific patient risks and benefits should be determined. Specifically, an explicit calculation of the benefit of anticoagulation and the risk of bleeding due to anticoagulation should be performed for each patient prescribed such treatment plans.

In an embodiment, a benefit and risk of oral anticoagulation for patients with atrial fibrillation may be calculated using validated clinical-prediction rules. Also, relevant information regarding the patient and/or care providers may be aggregated and processed from electronic medical records and/or other health information technology systems. Information needed for the calculation, but missing from the aggregated records may be identified. Collecting of the missing information may be initiated using the most cost effective human or automated agent (i.e., a call center agent) to gather the missing information. The benefit-risk calculation may be maintained, periodically updated throughout a patient's course of care and/or lifetime, or re-calculated as new information regarding the patient and/or the medication are identified. Also, the benefit-risk calculation may be transmitted or otherwise communicated in a useful format to appropriate care team members. Further, this embodiment may involve teaching and/or providing materials indicating how clinics can incorporate methods for putting the benefit-risk information into practice. Also, shared decision-making between multiple care team members, including the patient, may be facilitated with usable and useful system interfaces indicating the benefit-risk information and acceptance thereof by various care team members.

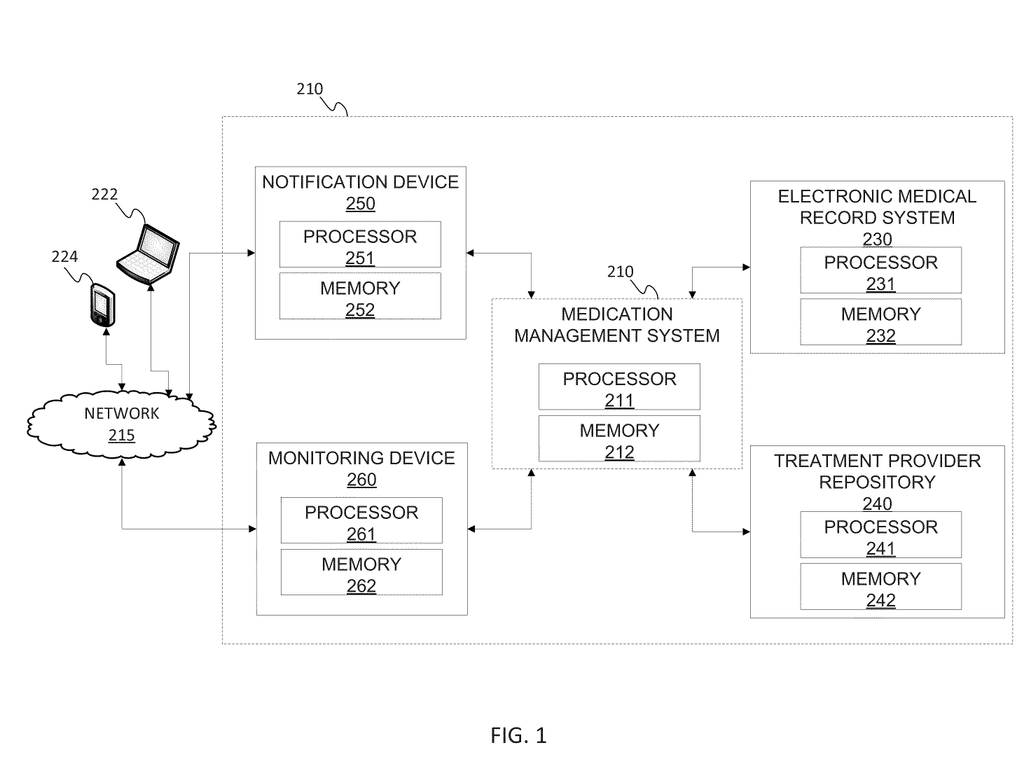

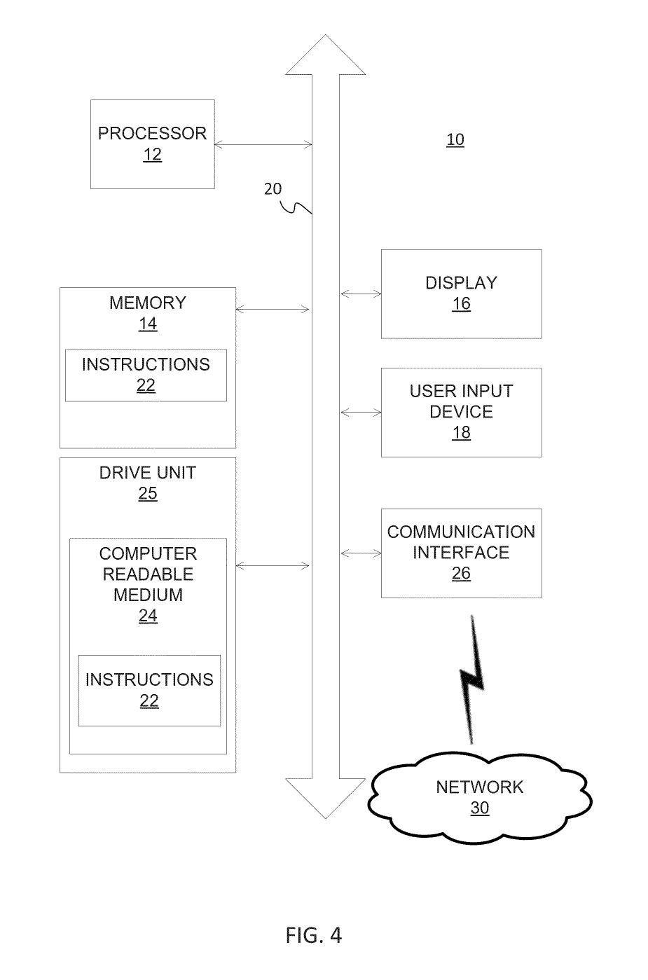

FIG. 1 illustrates a system for an embodiment medication management. The system may include a medication management system 210 which may interact with an electronic medical record system 230, a treatment provider repository 240, a notification device 250, and a monitoring device 260. The system also may be used to communicate and/or monitor medication based course of care information with a patient device 224 and a practitioner device 222 using the network 215. The respective devices, systems, and/or repositories may be implemented using the computer system 10 as described with respect to FIG. 4. For example, the network 215 may be the network 30, and the respective processors and memories may be processors 12 and memories 14 as described with respect to FIG. 4.

The system may include more or fewer components than those shown. For example, the medication management system 210, the notification device 250, and the monitoring device may each have independently operating processors 211, 251, 261 and memories 212, 252, 262, or they may share and/or distribute the processing resources throughout. Further, the medication management system 210, notification device 250, and monitoring device 260 may each use the same processor 211 and/or memory 212 to execute the actions required thereof. Also, the electronic medical record system 230 and/or the treatment provider repository 240 may use independently provided processors 231, 241 and memories 232, 242, a distribution of processing and memory resources among other components, or a central processor 211 and memory 212 of the medication management system.

In an embodiment, the medication management system may include each of the notification device 250, monitoring device 260, electronic medical record system 230, and the treatment provider repository 240. In another embodiment, the medication management system 210 may operate independent of the other devices, systems, and repositories shown. Any combination of the notification device 250, monitoring device 260, electronic medical record system 230, treatment provider repository and the management system 210 may be considered the medication management system as whole, or in part.

In an embodiment, the medication management system 210 identifies data indicative of an event relating to a medication. The event may involve a change related to the medication. The data may be identified from data input by a user. Also, the data may be identified from data contained in an EMR of the electronic medical record system 230. For example, an EMR of a patient may indicate that the patient is taking the medication, and data of the EMR may indicate a change, positive or negative, in the health of the patient. Further, the data may be generated by a mobile computing device 224 of the patient.

In an embodiment, the medication management system 210 evaluates a patient, or multiple patients, for self-administration of the medication. Patient characteristics, such as age, may be used to evaluate a patient for medication self-management. The evaluation may involve a request and/or reception of additional information regarding characteristics of the patient that may be applicable to a self-management determination. Such as activity level, particular desire for self-management, and/or other additional characteristics. In an embodiment, medication management system 210 communicates with the patient device 224 using the notification device 250 to generate a questionnaire, and/or other query, to a patient. The patient may then provide answers to the questionnaire using the patient device, and communicate the answers to the medication management system 210 using the monitoring device 260, or even the notification device 250.

The change related to the medication may be explicitly indicated by the data, such as a change in a field value of a database containing medication information, the change may be implied, or a combination thereof. For example, an implied change an adverse event occurrence related to the medication by a patient having various characteristics, such as female and of a certain age. These patient characteristics may be used as risk characteristics associated with the medication. Further, the change may involve an addition of one or more new characteristics, a modification of an existing characteristic, or any combination thereof and in any number of characteristics.

The patient device 224 may be any device operable to communicate information relating to a course of care for the patient. In an embodiment, the patient device may be equipped with circuitry and/or devices operable to measure patient characteristics such as vital signs or other measurable indicators of the physical condition of the patient. A patient device 224 having such capability may be considered a wearable medical device. For example, the patient device may include a thermometer in contact with the patient's skin that is configured to measure the body temperature of the patient. Other measuring devices may be included as well. The patient device 224 may also be configured to communicate this data directly to the course of care management system 210, or with the electronic medical record system 230 so as to update an EMR of the patient.

The medication management system 210 may also be configured to determine at least one task for a course of care of at least one patient due to the change related to the medication. For example, the event may be specifically associated with a particular task, or group of tasks such as a treatment plan, in an associative database. In an embodiment, the change may involve an addition of risk characteristics of a medication, and the task may involve notifying patients indicated by the risk characteristics of the risk. For example, a scientific study may indicate that a medication may cause a risk of stroke in patients over the age of 55. As such, all patients prescribed the medication and having an age over 55 may be identified and a notification task involving notifying the identified patients of the risk is determined. Also, a list of all such identified patients may be generated.

Tasks may be determined for patients based on patient characteristics. Patient characteristics may be identified from the electronic medical record system 230 using characteristics of the patient identified from particular EMRs of patients. The patient characteristics may be implied by the medication, or information relating to the medication. The information relating to the medication may indicate that an adverse effect has been identified for females taking the medication. The female characteristic of the adverse effect information may be used to match the patient characteristic, such as by a gender determination, or the medication information may imply the patient characteristic, such as by an age range implied by a risk characteristic of a medication as it implies a specific age of a patient indicated by an EMR. Patients may be determined for applicable tasks determined from changes or events related to a medication based on any patient characteristic, or combination of characteristics determined to meet the criteria indicated by the information relating to the medication.

The medication management system 210 may also be configured to access a treatment provider repository 240. The treatment provider repository 240 may include multiple treatment providers, each provider having associated attributes. The included treatment providers involve medical professionals, such as physicians and nurses, and may also involve other members of a patients potential care team, such as the patient, a relative of the patient, or any other person related to the care, or potential care, of patients.

The medication management system 210 may also be configured to select a treatment provider from the treatment provider repository 240 based on the change related to the medication, the provider attributes stored in the treatment provider repository 240, and/or at least one patient characteristic. The patient characteristic may be determined from an EMR of the patient stored in the electronic medical record system 230.

The medication management system 210 may also be configured to provide information for notifications regarding the medication. For example, the medication management system 210 may also be configured to designate the selected treatment provider as a designated treatment provider for at least one task determined based on the change related to the medication.

The notification device 250 is configured to receive information, generate notifications, and communicate the notifications via the network 215. The course of care information may be received by the notification device 250 and a notification may be generated with the information. For example, the notification may indicate the designated treatment provider and may be communicated with the provider device 222 and/or the patient device 224. Other course of care and medication information may be communicated as well. In an embodiment, the notification device 250 may generate a notification that indicates the event, the identified at least one patient, and/or data indicative of an adverse event by a particular patient to the medication. The adverse event may further be used as the data indicative of the event relating to the medication by the medication management system 210.

In an embodiment, the provider device 222 and/or the patient device 223 may be used to provide information to the medication management system 210 and/or the electronic medical record system 230 via the network 215. This information may be used to identify events and/or update the progress of tasks.

The monitoring device 260 may be used to send information to, and receive information from, the patient device 224 and the provider device 222 to monitor the status of tasks of a course of care. For example, a patient may enter data into the patient device 224 that indicates a completion of a medication dosage and consumption task. That information may be communicated to the monitoring device 260 wherein the task may be verified as completed using the communicated information. This monitoring data may be provided to the medication management system 210 and the notification device 250 may generate a notification that indicates the completion of the task. The notification device 250 may then communicate this notification with the provider device 222. Alternatively the status information may be generated by the provider device 222 and communicated to the monitoring device 260.

In an embodiment, the medication management system 210 may determine an action to take based on the returned status of the task. For example, a medication dosage and consumption task may be determined incomplete, such as by a detection of missing scheduled information to be returned by the patient. For example, an empty field of an EMR may indicate missing information. The medication management system 210 may determine that an action involving in-home contact with the patient may be required. This information may be included in a notification generated by the notification device 250 and communicated with the provider device 222 via the network 215.

In an embodiment, the medication management system 210 may identify at least one patient that is not using a medication, but may use the medication. The medication may have a newly established application for treating a patient condition. Patients not using the medication, but having characteristics, determined from the EMR system 230, indicating that the medication may be applicable to the patients, may be identified. These identified patients may be listed, provided notifications of the possibility of using the drug, and/or other information relating to the medication. Further, other treatment providers may also, or alternatively, be provided the information relating to the medication and an indication of the identified patients.

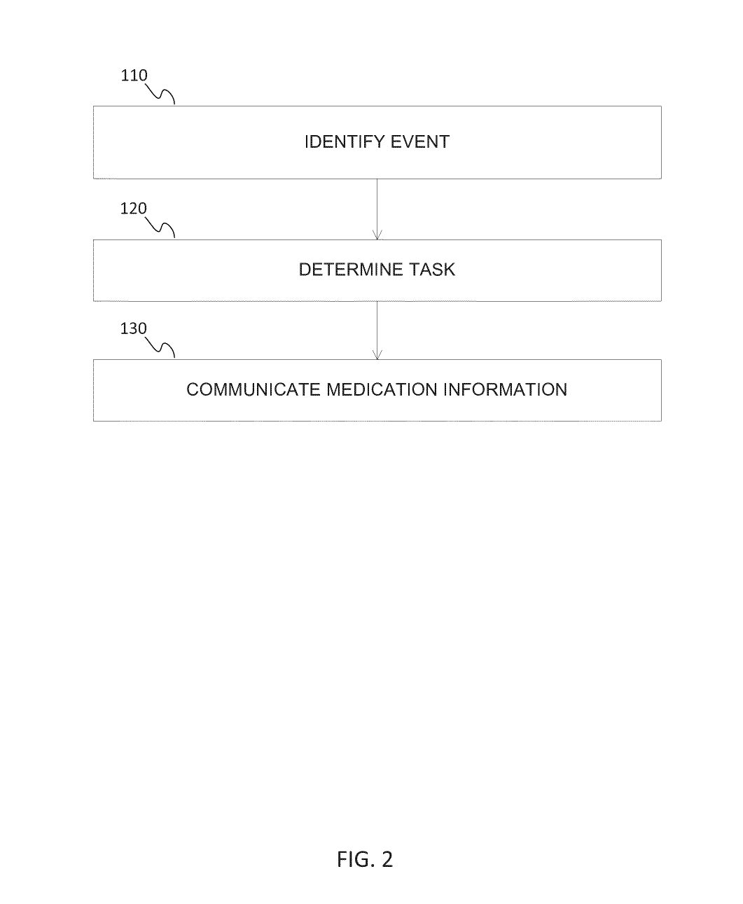

FIG. 2 shows a flow chart diagram of one embodiment of a method of medication management. The method is implemented by a computerized physician order entry (CPOE) system, an automated workflow system, a review station, a workstation, a computer, a picture archiving and communication system (PACS) station, a server, combinations thereof, or other information technology system in or associated with a medical facility, practitioner, care giver, and/or patient. For example, the system, processor, and/or computer readable media shown in FIG. 4 implements the method, but other systems may be used. For example, multiple computerized systems may interact and/or communicate to implement the method. Additional, different, or fewer acts may be performed.

In act 110, an event is identified. The event may be an event relating to a medication, such as an indication of a change related to a medication. The event may also be any event specific to a medication, such as a completion of a treatment plan milestone by a patient, the entry of the patient into a critical stage of a medication treatment plan, a beginning of a medication intervention, a completion of a medical treatment plan task, an availability of a new medication, a newly indicated application for a medication, identified risks of a medication, and/or any other event of a life of a medication. The event may be related to an unexpected change, such as a deviation in the health of the patient or performance of a task not part of the planned care of a patient relating to the medication.

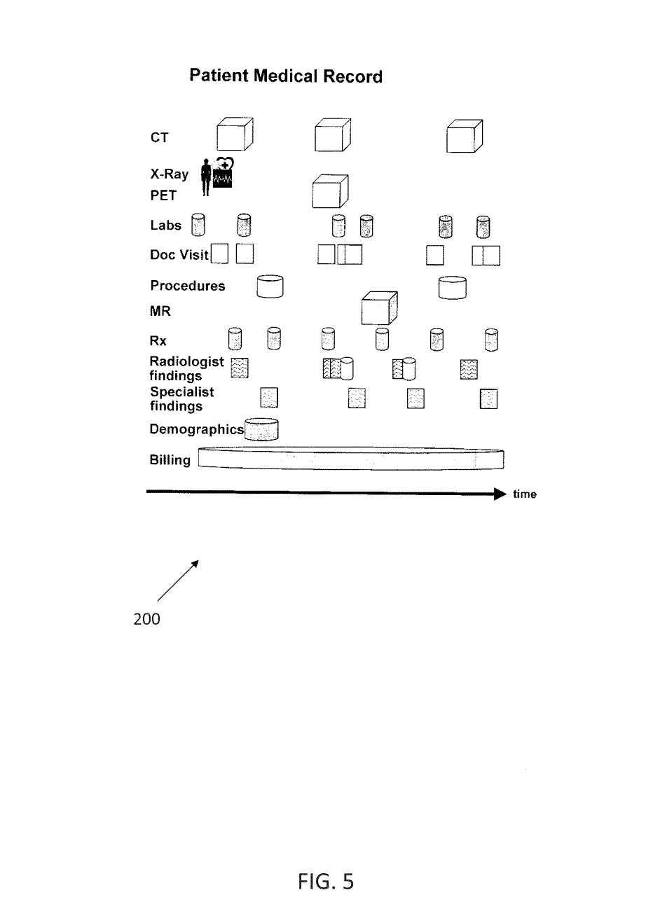

The event may be identified from any source. The event may be identified from data indicating an occurrence, or predicted occurrence, of the event. For example, an event may be identified as a characteristic, measureable medical value, or other information, in an electronic medical record (EMR) of a patient, such as the exemplary EMR 200 of FIG. 5. Also, the event may be the entry or modification of a characteristic, or multiple characteristics, of a medication.

Health care providers may employ automated techniques for information storage and retrieval. The use of an EMR to maintain patient information is one such example. As shown in FIG. 5, an exemplary EMR 200 includes information collected over the course of a patient's care by an institution, various providers, and/or other sources of care. The information may be collected using forms, form templates, form sections, or combinations thereof or other electronic data collection techniques. For example, information may be provided by wearable medical devices providing measured patient characteristics. Further, the information may include information from multiple sources including specialty purpose diagnostic machines, such as computed tomography, X-ray, ultrasound, or magnetic resonance machines. For example, computed tomography (CT) images, X-ray images, laboratory test results, doctor progress notes, details about medical procedures, prescription drug information, radiological reports, other specialist reports, demographic information, family history, patient information, and billing (financial) information as generated by various specialty purpose machines may be stored in an EMR 200. Any of this information may provide for information that may be used to identify an event, as indicated above, or identify patients for tasks related to medication characteristic changes, as indicated below.

An EMR may include a plurality of data sources, each of which typically reflects a different aspect of a patient's care. Alternatively, the EMR is integrated into one data source. Structured data sources, such as financial, laboratory, and pharmacy databases, generally maintain patient information in database tables. Information may also be stored in unstructured data sources, such as, for example, free text, images, and waveforms. Often, characteristics, such as key clinical findings, are stored within unstructured physician reports, annotations on images or other unstructured data source.

The information may be identified using any technique. For example, data mining may be used. Any data mining may be used, such as disclosed in U.S. Pat. No. 7,617,078. Also, data indicating an event may be specifically designated for the event. For example, an EMR may indicate specific dates or timing of the entry of critical stages for a treatment plan for a patient.

In act 120, a task may be determined. The task may be a task of a course of care for one or multiple patients. The task may be any task in the course of care and may be a change in a patient's course of care determined to be potentially beneficial to a patient's health based on the event identified in act 110. A task may be any task in the course of care of the patient. For example, a task may be the implementation of a treatment plan that involves other specific tasks to be performed during the course of care. The task may also involve a specific task to be completed with respect to the course of care. For example, a task may involve the disclosure and/or communication of documentation to a patient. The documentation may be required disclosure information such as specific risks and or benefits of a medication treatment plan for the patient, such as may be indicated by a change related to the medication. The task may be an alteration of the course of care, performance of a task in the course of care, establishing plans to perform a task or multiple tasks, notifying of alternative medications, and/or other task related to the course of care and/or change related to medication.

A task may be a specific task associated with a specific detected event. For example, a task may be the implementation or a continuance to a different stage of a warfarin sodium medication treatment plan for a patient based on a critical stage date specified in the patient's EMR and/or as implemented or discovered for warfarin sodium. The association may be stored directly in the patient's EMR, through an accessible database that provides directions for the implementation of treatment plans, or through any other technique.

The task may be determined based on the identified event in combination with other data. Patient characteristics, treatment provider characteristics, and/or other information may be combined with the detected event to determine a task.

In an embodiment, an event may be identified as the implementation of a medication treatment plan for a patient. The EMR of the patient may be accessed to determine characteristics such as gender and/or age of the patient. The combination of these characteristics and the identified event may indicate a change in a course of care. For example, the event may be the beginning of a medication treatment plan involving a teratogenic drug and the patient characteristics may indicate that the patient is female and at a child bearing age. As such, a task in the course of care may involve the presentation of the potential risks of the treatment plan to the patient and/or the inclusion of an evaluation task for a practitioner to evaluate the patient's suitability for the treatment plan. For example, a pregnancy test task may be added to the course of care along with a task involving the presentation and recordation of the patient's informed consent to the treatment plan. Other adverse drug event prediction and/or management tasks may also be a change in a course of care. For example, monitoring a patient for adverse events due to a treatment plan may involve detecting an adverse event, and changing the course of care for that patient and/or other patients to include corrective tasks.

Also, specific calculations to tailor treatment plans to particular patient characteristics may be a task in a course of care. For example, a medication may have a characteristic that indicates a benefit-risk data is needed, and benefit-risk data may be calculated for a particular patient upon the commencement of, or at various times during, an anti-coagulant treatment plan. The benefit-risk data may be determined using the patient's characteristics.

Treatment providers may also be designated for the task. For example, a task may be detected that indicates the commencement of a warfarin sodium treatment plan for a patient, and a treatment provider that has characteristics indicating that the provider is qualified for the warfarin sodium treatment plan may be selected as a designated provider for the patient to implement the treatment plan. In an embodiment, a task may involve the evaluation of the patient to determine if the patient is qualified for self-management of a treatment plan, such as a warfarin sodium medication treatment plan.

In an embodiment, the task may involve a calculation of a risk-benefit for a patient using the medication. The risk-benefit calculation may involve an analysis involving patient characteristics, as well as statistics involved in the use of the medication by patients. The risk-benefit may be a specific quantifiable value, or a subjective analysis of the factors indicating a good or bad result of use of the medication for a patient.

In act 130, medication information is communicated. The medication information may be any information relating to the medication, such as a change related to the medication identified as an event in act 120. For example, the medication information may be information indicating tasks associated with a medication characteristic. Schedules, dosages, activities, and other task specific information may be communicated. Specific providers selected to provide and/or oversee the treatment plan and/or tasks associated with the change in the course of care may receive the communication. Also, risks and/or benefits of the medication may be communicated, such as a listing of the risks associated with the undertaking of a particular treatment plan by patients having certain patient characteristics. The identified event may also be communicated.

The medication information may be communicated with any party associated with courses of care. For example, the information may be communicated with a patient, the patient's care team, medical facilities, as well as any other party associated with the course of care.

In an embodiment, the communicated medication information may include a risk-value determination for a medication. The risk-value may be quantitative or qualitative. Further, the risk-value may be related to a specific patient, or a group of patients sharing characteristics.

The information may be communicated using any technique. For example, electronic messages may be communicated that contain the information. The information may also be communicated using a display, communication interface, and/or other interactive device such as those described with respect to the system of FIG. 4. Further, the information may be communicated between multiple systems and/or devices, for example using the network 30 as described with respect to FIG. 4. For example, a first system used by a healthcare provider may communicate the information with a second system used by a patient using the network 30.

The information may be communicated with numerous individuals and entities, and over significant distances between remote locations, using such techniques. For example, a patient may be in the physical presence of a pharmacist that is providing a specific medication to the patient. The patient and the pharmacist may have access to a first system. The first system may identify an event relating to the prescribed medication, determine a task related to the commencement of a medication treatment plan, access an EMR of the patient on a second system that is physically located remotely from the first system and determine that the patient has characteristics that provide for a potentially dangerous interaction with the prescribed medication, based on the medication characteristics. The first system may contact a third remote system of a physician to evaluate the patient's case, and receive feedback from the physician regarding the evaluated risks of the medication treatment plan. The first system may further communicate risk information with a fourth system of the patient, such as a patient's mobile communication device.

In an embodiment, information indicating a risk for a medication is entered into a medication management system. The information entry is identified as an event relating to the medication. A task is determined relating to the entry of the risk information, such as a notification task. The task may be a notification task. For example, patients prescribed the medication may be identified and notified of the risk entered regarding the medication. The notification may come in any form, for example an email and or other electronic message. In an embodiment, a practitioner is selected to perform the notifying ether in person, or remotely through other communication techniques. The practitioner may be selected based on a relationship with a patient and/or a qualification for the notification task, as either specifically related to the medication and or subject matter of the risk.

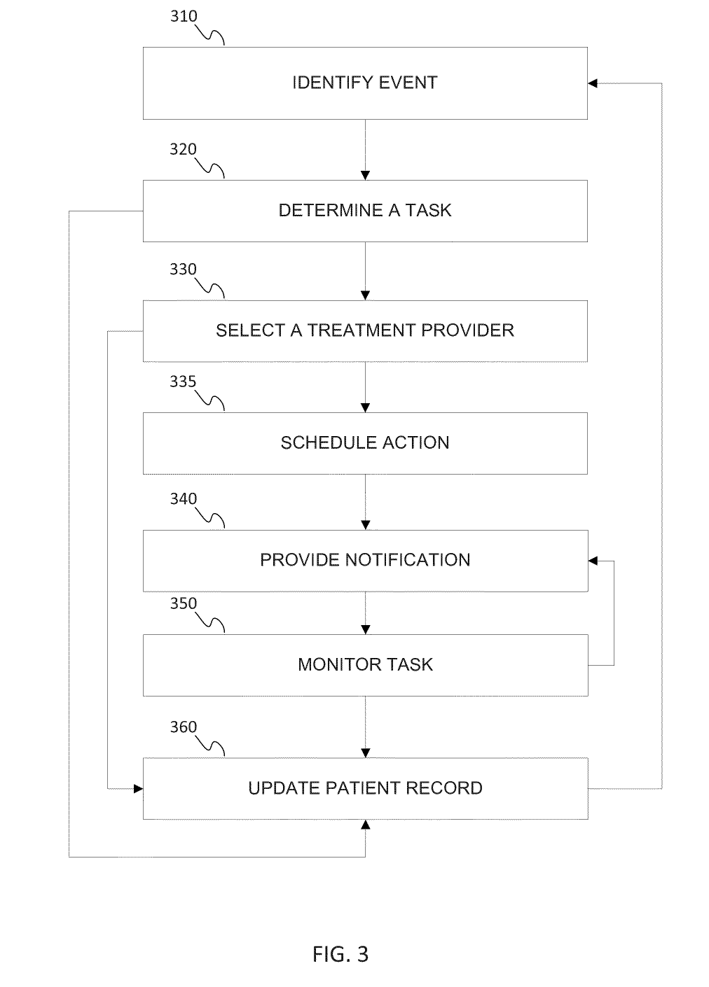

FIG. 3 is a flow chart diagram of one embodiment of a method managing medication. The method is implemented by a computerized physician order entry (CPOE) system, an automated workflow system, a review station, a workstation, a computer, a picture archiving and communication system (PACS) station, a server, combinations thereof, or other system in or associated with a medical facility, practitioner, care giver, and/or patient. For example, the system, processor, and/or computer readable media shown in FIG. 4 implements the method, but other systems may be used. For example, multiple computerized systems may interact and/or communicate to implement the method. Additional, different, or fewer acts may be performed. For example acts 350 and 360 may be omitted.

In act 310, an event may be identified. The event is an event relating to a medication. The event may be an event involving a medication. The event may be a change related to the medication. Also, a change to a medication may involve an introduction of the medication for use in treatments by patients. The event may be any event specific to a medication, such as events involving a singular patient or group of patients like a completion of a treatment plan milestone, the entry of a patient into a critical stage of a treatment plan, a beginning of a medication intervention, a completion of a medical treatment plan task, an entry of a medication into medical use, a discovery of an effect or application of the medication, and/or any other event of the life of the medication in use as a medical treatment. The event may be related to an unexpected change, such as a deviation in the health of the patient or performance of a task not part of the planned care. The event may be a change in condition of the patient. For example, the change in condition may be a raised blood pressure of a patient. The event may be the entry of information related to a new scientific study or medical standard related to the medication. The event may be a delineation of critical stages of intervention plans for patients with the medication.

The event may be identified from data stored in a computer, such as the computer system 10 described with respect to FIG. 4. The data may be received from a patient device and/or a practitioner device, such as a mobile device or a wearable medical device, and/or a workstation configured for entry of information relating to patients and/or medications. The data may also be stored in an electronic medical record storage system and/or a medication management system configured to provide information relating to specific medications such as characteristic information of the medications. The characteristic information may be any information relating to the medication, such as recommended dosages, applications, as well as other medication information. For example, incompatible patient characteristics, such as an age limit or minimum, may be associated or otherwise indicated. Further, general possible adverse effects as well as statistical information relating to those effects may be stored as characteristics of the medications.

In act 320, a task is determined. The task may be due to, or associated with, the identified event. For example, a task may be the implementation of a treatment plan that involves other specific tasks to be performed during the course of care.

The task may also involve a specific task to be completed with respect to the course of care of a patient. For example, the task may be the addition of a task involving a patient interview or examination by a cardiologist based on the detected increase in blood pressure detected from a patient. This patient characteristic may be determined in combination with a characteristic of a medication taken by the patient that presents a potential adverse effect being an increase in blood pressure. A patient record is updated with the task and/or data relating to the task in act 360.

Any number of patients may be identified for tasks due to the change related to the medication. For example, an electronic medical record system may be accessed and all patients currently and/or previously prescribed a medication may be identified and/or provided tasks.

Further, patient characteristics as coupled with medication characteristics may be used to determine affected patients. For example, a medication may have a characteristic added that indicates that females of child bearing age have a risk of an adverse effect due to a medication. As such, all females prescribed the medication of child bearing age (e.g. 15-45 years old) may be identified and determined a task of notifying of risks. Further future females of child bearing age being prescribed the information may be treated as an event and the notifying task for these patients may be determined. Also, a medication event may be a critical stage timing established for interventions with the medication. A patient characteristic may indicate an entry into this critical stage.

In an embodiment, determining a task involves identifying information missing from a patient characteristic of a particular patient required for determining the at least one task. For example, an electronic medical record may not include data indicative of an age for a patient, when an age is a patient characteristic indicated by a medication event. The missing data for the patient may be acquired. Acquiring the information may involve determining an information acquisition technique for acquiring the missing information. The information acquisition technique may be determined based on a set of standards or guidelines for information retrieval. For example, some sensitive information may require certain qualified practitioners to acquire the information. Such practitioners will be notified of the task involving acquisition of the information. Other information may be acquired more cheaply, by generally qualified persons of a call center. In an embodiment, a least expensive qualified method of acquisition is determined.

The information may then be acquired by the information acquisition technique. For example, a call center to be used to call the patient. In an embodiment, a message is communicated to a patient mobile device. The patient may use the patient mobile device to enter and/or otherwise specify the missing information. A return message may be sent to a medication management system with the missing information. The patient electronic medical record may also be updated with the missing information, and the medication management system may acquire the information from the EMR system. Also, the medication management system may have a listing or other association of patients having a particular program on a device and or membership into an information system. The medication management system may then determine existence of the patient within such an information system. If the patient is determined to exist in the system, the patient is contacted through that system. If the patient does not exist in that system, a practitioner or call center may be used to contact the patient to acquire the missing information.

In act 330, a treatment provider is selected. The treatment provider is selected for, and/or based on, the determined task. The treatment provider may be selected from a plurality of treatment providers, for example a plurality of treatment providers identified or designated as a patient's care team. A treatment provider may be a medical professional, such as a physician or nurse, or other persons. For example, other members of a care team for a patient may be a selected treatment provider, such as the patient themselves, a relative of the patient, or any other care giver associated with the care of a patient.

A treatment provider may be selected for a singular task, or a group or collection of tasks relating to the medication. For example, a task may be the implementation of a series of test for a patient, each of which may be considered an individual task. A single practitioner may be selected for each of the tasks, as indicated by the change related to the medication. For example, a treatment provider may be selected to administer a series of tasks associated with a medical intervention for a patient.

The treatment provider may be selected using other criteria as well. For example, patient characteristics and/or treatment provider attributes may be used.

Provider attributes may be any characteristic related to a treatment provider. For example, qualification and/or costs for the performance or oversight of a particular treatment plan may be treatment provider characteristics. Other information may also be a provider characteristic. For example, physician ratings, location relative to a home address of the patient, physician gender, length of experience in various practice areas, and/or any other characteristics may be used.

As indicated above, the treatment provider may also be selected based on treatment provider characteristics, such as qualifications and/or costs. For example, the treatment provider may be qualified as a cardiologist. Also, a plurality of candidate treatment providers may have a first attribute indicating a qualified status for the at least one task. The designating of one of the candidate treatment providers as the selected treatment provider may be based on a second provider attribute, such as cost, availability, ranking, frequency of assignment, or other attribute. For example, if multiple cardiologists are selected, the cardiologist with the lowest cost for the associated course of care task may be selected. In an embodiment, the EMRs of patients may be updated, for example in act 360, with the change in the task and the selected treatment provider.

Patient characteristics may be any characteristics related to a patient, such as age, gender, existence of a medical condition, measured vital signs, patient care preferences, and/or any other characteristics relating to the physical, mental, and/or financial state of a patient. Patient characteristics may also involve patient goals, patient preferences, patient capabilities, and/or any other characteristics of the patient related to the course of care. Any combination of patient characteristics may also be used.

Patient characteristics may be determined by any method. In an embodiment, known clinical standards and diagnosis criteria are used. In an embodiment, characteristics are learned through a machine learned model. Also, the locations of specific patient characteristics in an EMR may be mapped, and this map may be referenced to locate values for these characteristics. Further, specific characteristics may be mined from a singular EMR or a multiple EMRs for a patient. A treatment provider may be selected based on the change in the course of care and patient characteristics. For example, a patient may have a preference for female physicians indicated in the patient's EMR. This preference may be used to identify a qualified physician that has a gender characteristic specified as female. In another example, a patient may have a cost limit associated with care tasks, and a provider having an appropriate, i.e. less than the cost limit, may be selected. Further, insurance type and/or coverage specifics for a patient may be used to determine a treatment provider. For example, a patient may have a specific insurance policy, and a provider may be selected that is covered under the particular insurance policy.

In act 335, an action may be scheduled for the task. The action may be any action related to the task. For example, an action may be the establishment of an in-office appointment between a patient and the selected treatment provider. An electronic schedule for the selected treatment provider and/or a facility associated with the selected treatment provider to determine a scheduled date and/or time.

In act 340, notification is provided. Notification may be in any form operable to notify a person or an entity of information. Notification may be a notification such as an electronic message containing information related to the course of care of the patient. The notification may indicate that the selected treatment provider is a designated treatment provider for the task to be performed. Also, the notification may include information indicating the identified event, the change medication characteristic, information relating to the change in the characteristics of the medication such as associated risks, and/or any other information related to the medication. For example, the notification may also include information indicating an action that has been scheduled related to the changed course of care, such as the action scheduled in act 335. In another example, the notification may describe the risks that were indicated as a change related to the medication.

Notification may be provided to any person or entity associated with a patient's course of care and/or care team. A patient, designated treatment provider, care team members, facility management, and/or any other person or entity associated with the course of care of a patient may be provided notification. For example, the designated cardiologist for the patient's high blood pressure examination may be provided a notification that indicates the selection as the designated provider for the task.

In an embodiment, a patient is provided with a patient notification that indicates the designated treatment provider, the at least one task, and disclosure information related to the related to the change related to the medication

In act 350, the task is monitored. The monitoring may involve monitoring the treatment of a patient during a course of care. The monitoring may involve sending information and receiving responses from patients and/or practitioners. The information and responses may involve data indicating a status of tasks associated with a course of care. For example, a cardiologist may prescribe a course of care that involves a high blood pressure medication treatment plan for the patient. The patient may use a device to generate and send data to the cardiologist indicating the successful completion, or lack of completion, of each dosing and consumption event of the treatment plan. This data may be received and a notification of the status information may be communicated with the designated provider. Further, based on the status information the designated cardiologist may be provided with a notification that indicates the status of the task and an action to take associated with the task. For example, if the task is indicated as incomplete, the notification may indicate that patient in-home visit action should be undertaken by the designated cardiologist, or another member of the care team.

Monitoring may also indicate and/or detect an event used to determine a change related to a medication. For example, a patient may be undergoing a medication treatment plan. An adverse reaction to the medication may be detected through the monitoring, such as from the EMR of the patient having updated medication treatment plan data. This adverse reaction event may trigger the determination of a task in the course of care of the patient, such as changing the specific medication and/or dosage of the existing medication.

Also, providing notification and monitoring treatment may be repeated during the course of care of a patient. For example, when the monitoring indicates an unsuccessful or missed task, a reminder notification may be generated and provided to the patient and/or the designated provider. Also, task risk information may be provided to a patient based on treatment results. For example, treatment results and/or status may indicate that the patient is having an adverse reaction to a medication and notifications may be provided to practitioners and/or the patient to intervene in the treatment plan. In this example, reactions may be graded based on severity, and severe reaction may involve notification being provided urgently or in real-time. Further, other patients, such as other patients prescribed the medication and/or having similar patient characteristics may have tasks determined based on the adverse effect event.

In act 360, a patient record is updated. The patient record may be an EMR of the patient in an electronic medical record system. The record may be updated with information regarding the course of care, such as monitored treatment plan results and/or other information relating to tasks of the course of care. The monitored results that are updated into the patient record may also be used to identify an event in act 310.

FIG. 4 provides an illustrative embodiment of a general computer system 10 for medication management. The computer system 10 can include a set of instructions that can be executed to cause the computer system 10 to perform any one or more of the methods or computer based functions disclosed herein. The computer system 10 may operate as a standalone device or may be connected, e.g., using a network, to other computer systems or peripheral devices. Any of the embodiments discussed above may be implemented using the computer system 10, multiple computer systems 10, or a component in the computer system 10.

In a networked deployment, the computer system 10 may operate in the capacity of a server or as a client user computer in a client-server user network environment, or as a peer computer system in a peer-to-peer (or distributed) network environment. The computer system 10 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a wearable medical device, a network router, switch or bridge, or any other machine capable of executing a set of instructions (sequential or otherwise) that specify actions to be taken by that machine. In a particular embodiment, the computer system 10 can be implemented using electronic devices that provide voice, video or data communication. Further, while a single computer system 10 is illustrated, the term “system” shall also be taken to include any collection of systems or sub-systems that individually or jointly execute a set, or multiple sets, of instructions to perform one or more computer functions.

As illustrated in FIG. 4, the computer system 10 may include a processor 12, e.g., a central processing unit (CPU), a graphics processing unit (GPU), or both. The processor 12 may be a component in a variety of systems. For example, the processor 12 may be part of a standard personal computer or a workstation. The processor 12 may be one or more general processors, digital signal processors, application specific integrated circuits, field programmable gate arrays, servers, networks, digital circuits, analog circuits, combinations thereof, or other now known or later developed devices for analyzing and processing data. The processor 12 may implement a software program, such as code generated manually (i.e., programmed).

In an embodiment, the processor 12 may be configured to cause the system 10 to identify data indicative of an event relating to the medication, the event involving a change related to the medication, determine at least one task for a course of care of at least one patient due to the change related to the medication, select, by accessing the treatment provider repository, at least one treatment provider for the at least one patient, the treatment provider selected from a plurality of treatment providers having associated provider attributes, and the selecting being based on the change related to the medication, the provider attributes, and at least one patient characteristic from a patient medical record database, and provide to the selected at least one treatment provider a notification that indicates the event, the identified at least one patient, and that the selected treatment provider is a designated treatment provider for the at least one task.

The computer system 10 may include a memory 14 that can communicate via a bus 20. The memory 14 may be a main memory, a static memory, or a dynamic memory. The memory 14 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 14 includes a cache or random access memory for the processor 12. In alternative embodiments, the memory 14 is separate from the processor 12, such as a cache memory of a processor, the system memory, or other memory. The memory 14 may be an external storage device or database for storing data. Examples include a hard drive, compact disc (“CD”), digital versatile disc (“DVD”), memory card, memory stick, floppy disc, universal serial bus (“USB”) memory device, or any other device operative to store data. The memory 14 is operable to store instructions executable by the processor 12. The functions, acts or tasks illustrated in the figures or described herein may be performed by the programmed processor 12 executing the instructions 22 stored in the memory 14. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

In an embodiment, the memory 14 and/or computer readable medium 24 may be operable to store a database comprising a treatment provider repository having a plurality of treatment providers, the plurality of treatment providers associated with provider attributes, and an electronic patient medical record database.

As shown, the computer system 10 may further include a display unit 16, such as a liquid crystal display (LCD), an organic light emitting diode (OLED), a flat panel display, a solid state display, a cathode ray tube (CRT), a projector, a printer or other now known or later developed display device for outputting determined information. The display 16 may act as an interface for the user to see the functioning of the processor 12, or specifically as an interface with the software stored in the memory 14 or in the drive unit 25. The display 16 may be operable to present notifications containing information regarding a medical course of care.

Additionally, the computer system 10 may include an input device 18 configured to allow a user to interact with any of the components of system 10. The input device 18 may be a number pad, a keyboard, or a cursor control device, such as a mouse, or a joystick, touch screen display, remote control or any other device operative to interact with the system 10. The input device 18 may be configured to receive information from a user regarding a medical course of care.

In a particular embodiment, as depicted in FIG. 4, the computer system 10 may also include a disk or optical drive unit 25. The disk drive unit 25 may include a computer-readable medium 410 in which one or more sets of instructions 22, e.g. software, can be embedded. Further, the instructions 22 may embody one or more of the methods or logic as described herein. In a particular embodiment, the instructions 22 may reside completely, or at least partially, within the memory 14 and/or within the processor 12 during execution by the computer system 10. The memory 14 and the processor 12 also may include computer-readable media as discussed above.

As is also indicated above, in an embodiment, the memory 12 and/or the computer readable medium 24 may be operable to store a database comprising a treatment provider repository having a plurality of treatment providers, the plurality of treatment providers associated with provider attributes, and an electronic patient medical record database

The present disclosure contemplates a computer-readable medium that includes instructions 22 or receives and executes instructions 22 responsive to a propagated signal, so that a device connected to a network 30 can communicate video, audio, images, text, or any other data over the network 30. Further, the instructions 22 may be transmitted or received over the network 30 via a communication interface 26. The communication interface 26 may be a part of the processor 12 or may be a separate component. The communication interface 26 may be created in software or may be a physical connection in hardware. The communication interface 26 is configured to connect with a network 30, external media, the display 16, or any other components in system 10, or combinations thereof. The connection with the network 30 may be a physical connection, such as a wired Ethernet connection or may be established wirelessly as discussed below. Likewise, the additional connections with other components of the system 10 may be physical connections or may be established wirelessly.

In an embodiment the instructions 22 may be operable when executed by the processor 12 to cause the system 10 to identify data indicative of an event relating to the medication, the event involving a change related to the medication, determine at least one task for a course of care of at least one patient due to the change related to the medication, selecting, by the processor 12 accessing a treatment provider repository in a database, at least one treatment provider for the at least one patient, the treatment provider selected from a plurality of treatment providers having associated provider attributes, and the selecting being based on the change related to the medication, the provider attributes, and at least one patient characteristic from a patient medical record database, and provide to the selected at least one treatment provider a notification that indicates the event, the identified at least one patient, and that the selected treatment provider is a designated treatment provider for the at least one task.

The network 30 may include wired networks, wireless networks, or combinations thereof. The wireless network may be a cellular telephone network, an 802.11, 802.16, 802.20, or WiMax network. Further, the network 30 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), or a tablet device, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

I (we) claim:

1. A method of managing a medication, the method comprising:
identifying, by a processor, data indicative of an event relating to the medication, the event involving a change related to the medication;
determining, by the processor, at least one task for a course of care of at least one patient due to the change related to the medication;
selecting, by the processor accessing a treatment provider repository in a database, at least one treatment provider for the at least one patient, the treatment provider selected from a plurality of treatment providers having associated provider attributes, and the selecting being based on the change related to the medication, the provider attributes, and at least one patient characteristic from a patient medical record database; and
providing, by the processor, to the selected at least one treatment provider a notification that indicates the event, the identified at least one patient, and that the selected treatment provider is a designated treatment provider for the at least one task.

2. The method of claim 1, wherein the selecting the at least one treatment provider for the at least one task comprises selecting the treatment provider for a plurality of tasks of a treatment plan for the at least one patient.

3. The method of claim 2, wherein the selecting the at least one treatment provider for a plurality of tasks of a treatment plan for the patient comprises tasks associated with a medication intervention of the course of care of the patient.

4. The method of claim 1, further comprising:
receiving, by the processor from a remote device, data indicative of a status of the at least one task; and
providing, by the processor, to the at least one designated treatment provider a notification that indicates the status of the at least one task and a proposed action to be undertaken by the designated at least one treatment provider based on the status of the at least one task.

5. The method of claim 4, wherein the receiving data indicative of the status of the at least one task comprises receiving data indicative of an adverse event occurrence in a patient.

6. The method of claim 5, wherein the data indicative of the adverse event is identified as the event involving the change related to the medication.

7. The method of claim 1, wherein the determining at least one task for a course of care of at least one patient further comprises:
identifying information missing from a patient characteristic of a particular patient required for determining the at least one task;
determining an information acquisition technique for acquiring the missing information; and
acquiring the missing information using the information acquisition technique.

8. The method of claim 7, wherein the determining an information acquisition technique comprises:
communicating a message to a patient mobile device; and
receiving the missing information in a reply message communicated from the patient mobile device.

9. The method of claim 1, wherein the determining the at least one task for the course of care of the at least one patient due to the change related to the medication comprises identifying patient characteristics from an electronic medical record of the at least one patient that are implicated by the change related to the medication.

10. The method of claim 9, wherein the identifying data from the electronic medical record of the at least one patient comprises identifying data indicative of an entry into a critical stage defined for the medication based on the change in the characteristic for the medication.

11. The method of claim 1, wherein the selecting at least one treatment provider for the at least one task comprises identifying a plurality of candidate treatment providers that have a first attribute indicating a qualified status for the at least one task, and designating one of the candidate treatment providers as the designated treatment provider based on a second provider attribute.

12. The method of claim 11, wherein the second provider attribute comprises a cost associated with the performance of the at least one task by the candidate treatment providers.

13. The method of claim 12, wherein the patient is identified as a candidate treatment provider, and the patient is the designated treatment provider indicated as having the lowest cost.

14. The method of claim 1, wherein the provider attributes comprise information indicating a cost of care for the care plan component for the plurality of treatment providers, and wherein the selecting a treatment provider comprises selecting the treatment provider having a lowest cost of care for the care plan component.

15. The method of claim 1, wherein the notification further indicates patient disclosure information related to the change related to the medication.

16. The method of claim 1, further comprising:
providing the patient with a patient notification that indicates the designated treatment provider, the at least one task, and disclosure information related to the related to the change related to the medication.

17. The method of claim 16, wherein providing the patient with a patient notification that indicates disclosure information related to the change to the medication comprises providing the patient with a patient notification that describes risks associated with the medication, the risks being at least a part of the change related to the medication.

18. A system for managing a medication, the system comprising:
at least one memory operable to store a database comprising a treatment provider repository having a plurality of treatment providers, the plurality of treatment providers associated with provider attributes, and an electronic patient medical record database; and
a processor configured to:
identify data indicative of an event relating to the medication;
determine at least one task for a course of care of at least one patient due to the event relating to the medication;
select, by accessing the treatment provider repository, at least one treatment provider for the at least one patient, the treatment provider selected from a plurality of treatment providers having associated provider attributes, and the selecting being based on the event related to the medication, the provider attributes, and at least one patient characteristic from a patient medical record database; and
provide to the selected at least one treatment provider a notification that indicates the event, the identified at least one patient, and that the selected treatment provider is a designated treatment provider for the at least one task.

19. The system of claim 18, wherein the processor is further configured to:
receive data indicative of the status of at least one task of a treatment plan involving the medication; and
provide to the designated treatment provider a status notification that indicates the status of the at least one task and a particular patient associated with the task.

20. The system of claim 19, wherein the data indicative of the status of the at least one task is identified as data indicative of the event relating to the medication.

21. The system of claim 20, wherein the data indicative of the event comprises data indicative of an adverse reaction to the medication by the particular patient.

22. The system of claim 18, wherein the notification further indicates risks indicated by the event relating to the medication.

23. The system of claim 22, wherein the indicated risks include information indicating a risk-value determination calculated based at least on patient characteristics of the at least one patient.

24. The system of claim 18, wherein the processor is further configured to determine at least one task for a course of care of a plurality of patients, and wherein the notification further comprises a list of the plurality of patients.

25. The system of claim 24, wherein the plurality of patients are patients who are not currently taking the medication.

26. A system for managing a medication, the system comprising:
an electronic medical record system comprising a plurality of electronic medical records of patients;
a treatment provider repository comprising a plurality of treatment providers having associated provider attributes, wherein the plurality of treatment providers include care team members;
a medication management system configured to identify data indicative of a change relating to the medication, determine at least one task for a course of care of at least one patient due to the change relating to the medication, select, by accessing the treatment provider repository, at least one treatment provider from a care team for the at least one patient, the treatment provider selected from a plurality of treatment providers having associated provider attributes, and the selecting being based on the change relating to the medication, the provider attributes, and at least one patient characteristic from a patient medical record database;
a monitoring device configured to receive data indicative of the status of the course of care of the at least one patient; and
a notification device configured to provide to the selected at least one treatment provider a notification that indicates the event, the identified at least one patient, that the selected treatment provider is a designated treatment provider for the at least one task, and data indicative of an adverse event by a particular patient to the medication, wherein the adverse event is the data indicative change relating to the medication.

27. The system of claim 26, wherein the notification device is further configured to send the at least one patient a patient notification indicating the event, that the selected treatment provider is a designated treatment provider for the at least one task, and data indicative of an adverse event by a particular patient to the medication, wherein the adverse event is the data indicative change relating to the medication.

28. The system of claim 26, wherein the medication management system is further configured to evaluate the at least one patient for self-administration of the medication.
